(19) United States
(12) Patent Application Publication
(10) Pub. No.: US 2026/0303927 A1
(43) Pub. Date: Oct. 1, 2026

(54) METHOD, APPARATUS, DEVICE, AND STORAGE MEDIUM FOR CONTENT POSTING

(71) Applicant: Bytedance Technology Ltd., Grand Cayman (KY)

(72) Inventors: Lingxuan Shen, Beijing (CN); Jialu Li, Beijing (CN); Zhenan Li, Beijing (CN)

(21) Appl. No.: 19/635,239

(22) Filed: Mar. 31, 2026

(30) Foreign Application Priority Data
Mar. 31, 2025 (CN) 202510397017.3

(51) Int. Cl. H04N 21/81; H04N 21/2743; H04N 21/431

(52) U.S. Cl. CPC H04N 21/8113; H04N 21/2743; H04N 21/4318

(57) ABSTRACT

A method, an apparatus, a device, and a storage medium for content posting are provided. In a method, a first entry is presented in a viewing interface of music content. A first editing interface is presented in response to the first entry being triggered. The first editing interface presents a first media material of a group of media materials, and the group of media materials is determined from a media content set based on a relevance between the music content and the media content set. In response to a posting entry in the first editing interface being triggered, first media content corresponding to the first media material presented in the first editing interface is posted.

### CROSS-REFERENCE

This application claims priority to CN Application No. 202510397017.3, filed on Mar. 31, 2025, and entitled “METHOD, APPARATUS, DEVICE, AND STORAGE MEDIUM FOR CONTENT POSTING”, the entirety of which is incorporated herein by reference.

### FIELD

Example embodiments of the present disclosure generally relate to the field of computers, and in particular, to a method, an apparatus, a device, and a computer-readable storage medium for content posting.

### BACKGROUND

With the development of computer levels, electronic devices in various forms may greatly enrich people's daily lives. For example, people may utilize the electronic devices for content posting. How to improve the efficiency of content posting has become a focus issue of concern.

### SUMMARY

In a first aspect of the present disclosure, a method of content posting is provided. The method includes: presenting a first entry in a viewing interface of music content; presenting a first editing interface in response to the first entry being triggered, the first editing interface presenting a first media material of a group of media materials, and the group of media materials being determined from a media content set based on a relevance between the music content and the media content set; and posting, in response to a posting entry in the first editing interface being triggered, first media content corresponding to the first media material presented in the first editing interface.

In a second aspect of the present disclosure, an apparatus for content posting is provided. The apparatus includes: a first presenting module configured to present a first entry in a viewing interface of music content; a second presenting module configured to present a first editing interface in response to the first entry being triggered, the first editing interface presenting a first media material of a group of media materials, the group of media materials being determined from a media content set based on a relevance between the music content and the media content set; and a posting module configured to post, in response to a posting entry in the first editing interface being triggered, first media content corresponding to the first media material presented in the first editing interface.

In a third aspect of the present disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a non-transitory computer-readable storage medium is provided. The non-transitory computer-readable storage medium has a computer program stored thereon, and the computer program is executable by a processor to implement the method of the first aspect.

It should be understood that the content described in this content section is not intended to limit the key features or major features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIGS. 2A-2O illustrate example interfaces according to some embodiments of the present disclosure;

FIG. 3 illustrates a flowchart of an example process of content posting according to some embodiments of the present disclosure;

FIG. 4 illustrates a schematic structural block diagram of an example apparatus for content posting according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as being limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiment described in the same section/subsection and/or different sections/subsections.

In the description of the embodiments of the present disclosure, the terms “including” and the like should be understood to mean open-ended inclusion, i.e., “including but not limited to”. The term “based on” should be understood as “based at least in part on”. The terms “an embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related provisions. In the embodiments of the present disclosure, all data collection, acquisition, treatment, processing, forwarding, use and the like are performed on the premise that the user knows and confirms. Accordingly, when implementing the embodiments of the disclosure, the type, the usage scope, the usage scenario, and the like of the data or information that may be involved should be notified to the user and obtain the authorization from the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legal basis (for example, obtaining consent of a personal information subject, or necessary for performing a fulfillment contract), and processing may be performed only within a specified or agreed range. In the case that the user refuses personal information other than necessary information required by the basic function, the use of the basic function will not be affected.

With the rapid development of Internet technologies, the field of media content creation constantly emerges new technologies and modes, for example, a music template-based mode. In the music template-based mode, a user may be allowed to refer to media content posted by others, using the same music as a soundtrack to create similar media works. In some specific scenarios, the user may use music as a background, and further add materials such as an image or a video to create the media content.

An embodiment of the present disclosure provides a solution of content posting. According to this solution, a first entry may be presented in a viewing interface of music content. Further, the first editing interface may be presented in response to the first entry being triggered. The first editing interface presents a first media material of a group of media materials, and the group of media materials is determined from a media content set based on a relevance between the music content and the media content set. Additionally, the first media content corresponding to the first media material presented in the first editing interface may be posted in response to a posting entry in the first editing interface being triggered.

In this way, the embodiments of the present disclosure may present a first entry on a viewing interface of music content to support more rapid creation of the media content. The user may quickly create the media content based on the music content without switching to other interfaces or performing additional steps, so that the cost of content posting can be reduced, and the efficiency of content posting can be improved. In addition, the embodiments of the present disclosure may recommend at least the first media material to the user based on a relevance between the music content and the media content set. The user does not need to manually select materials, further improving the efficiency of content posting, and improving the quality of the posted media content.

Thus, the embodiments of the present disclosure can improve the efficiency of content posting and improve the quality of the posted media content.

Various example implementations of this solution are described in detail below in conjunction with the accompanying drawings.

### Example Environment

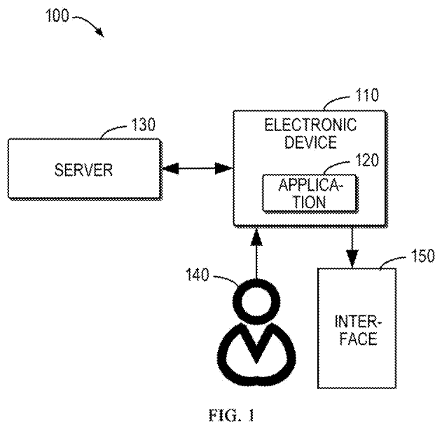

FIG. 1 illustrates a schematic diagram of an example environment 100 in which embodiments of the present disclosure may be implemented. As shown in FIG. 1, the example environment 100 may include an electronic device 110.

In this example environment 100, the electronic device 110 may run an application 120 that supports content (e.g., images, videos, etc.) posting. The application 120 may be any suitable type of application for content posting, examples of which may include, but are not limited to, a media content editing application, a video application, a social application, or other suitable applications. The user 140 may interact with the application 120 via the electronic device 110 and/or its attachment device.

In the environment 100 of FIG. 1, if the application 120 is in an active state, the electronic device 110 may present, through the application 120, an interface 150 for supporting interface interaction.

In some embodiments, the electronic device 110 communicates with a server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, a distributed system or a server cluster composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the application 120 that supports content presentation in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (Wi-Fi) connection, and the like, and the embodiments of the present disclosure are not limited in this regard. In the embodiments of the present disclosure, the server 130 and the electronic device 110 may implement signaling interaction through a communication connection between the server 130 and the electronic device 110.

It should be understood that the structures and functions of various elements in the environment 100 are described for illustrative purposes only and do not imply any limitation to the scope of the present disclosure.

Some example embodiments of the present disclosure will be described below with continued reference to the accompanying drawings.

### Example Interaction

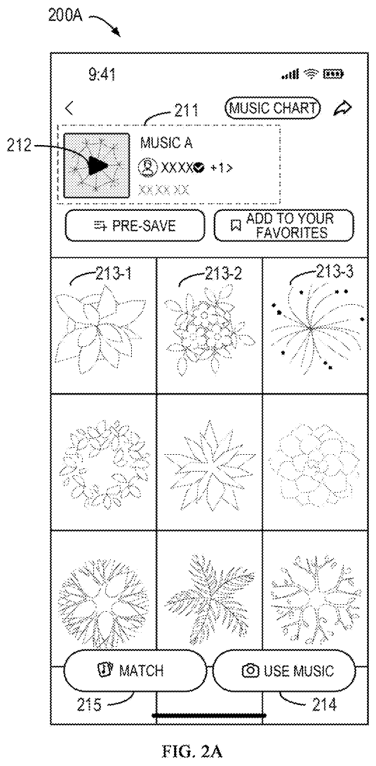

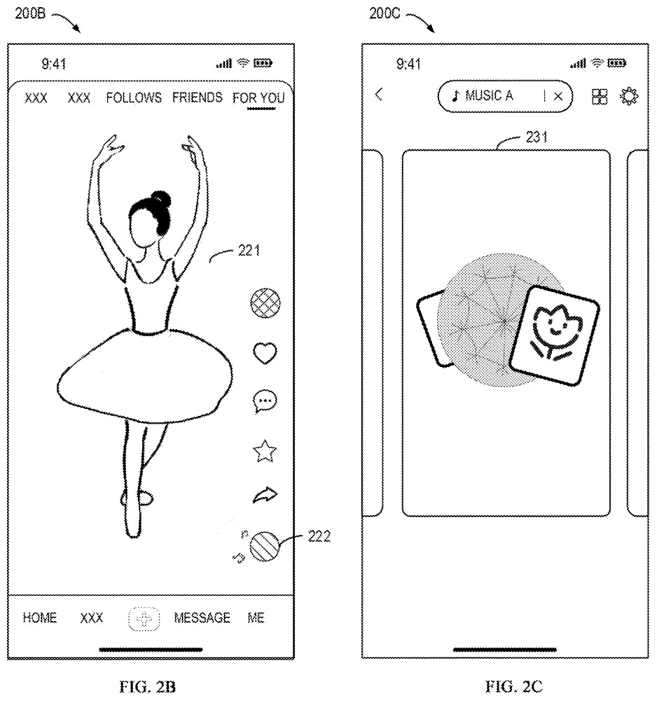

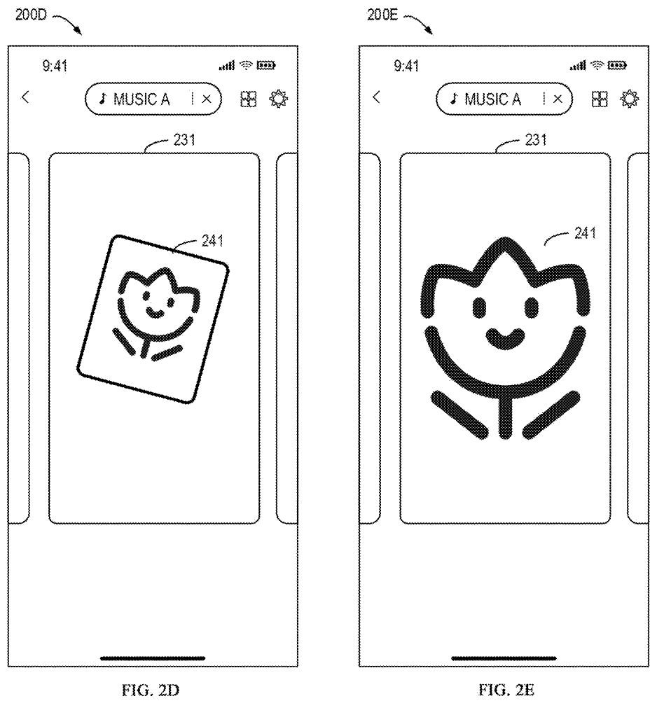

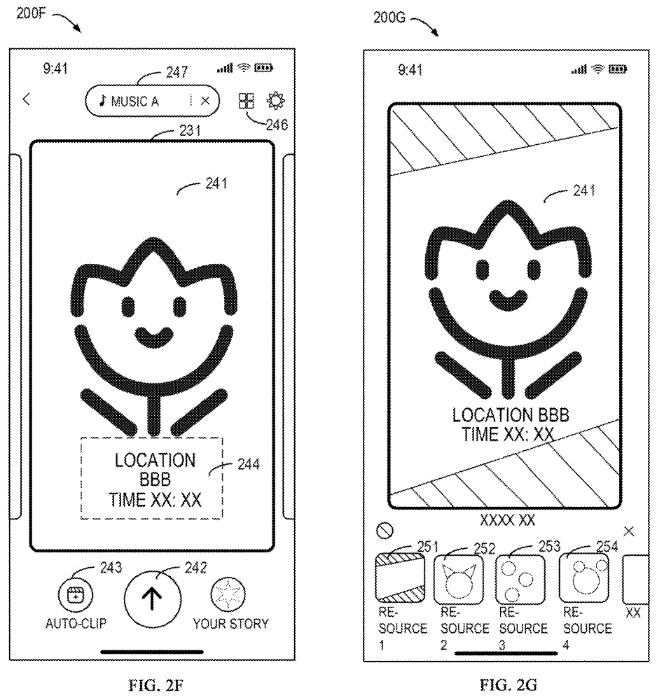

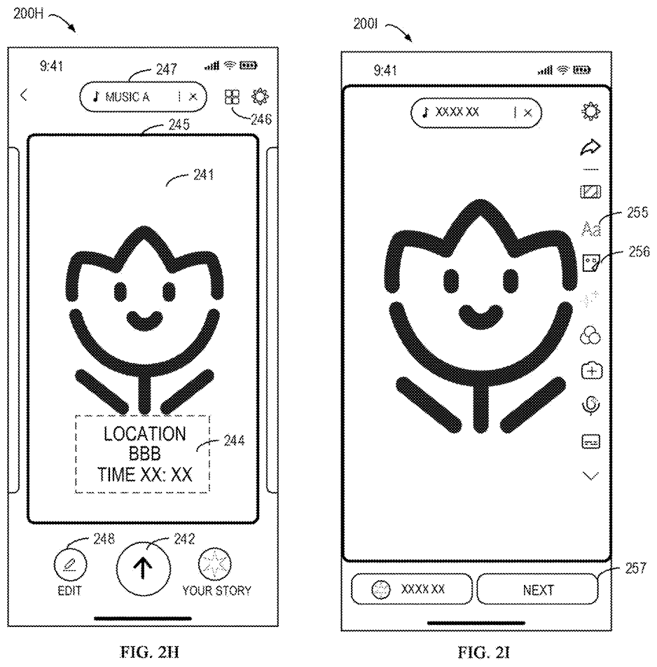

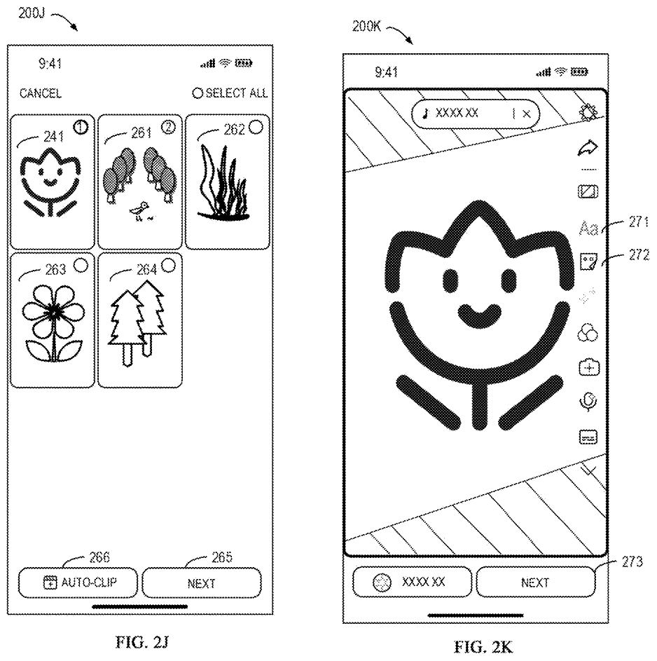

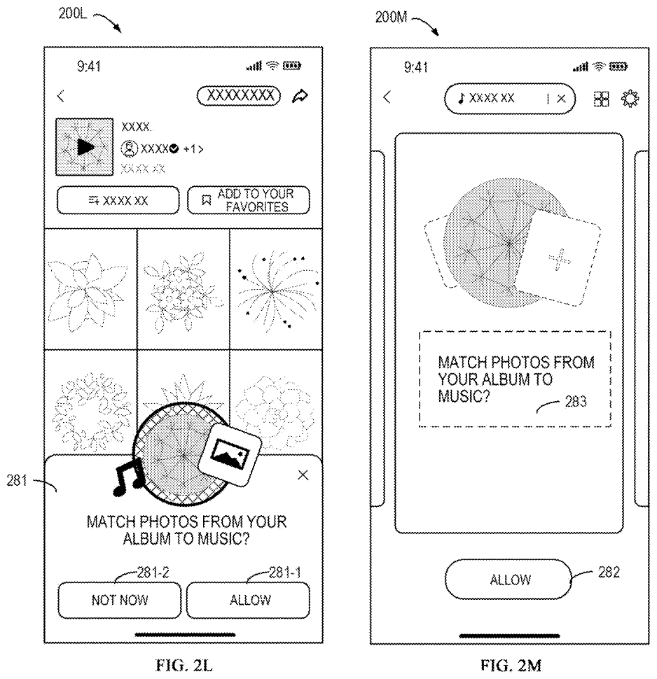

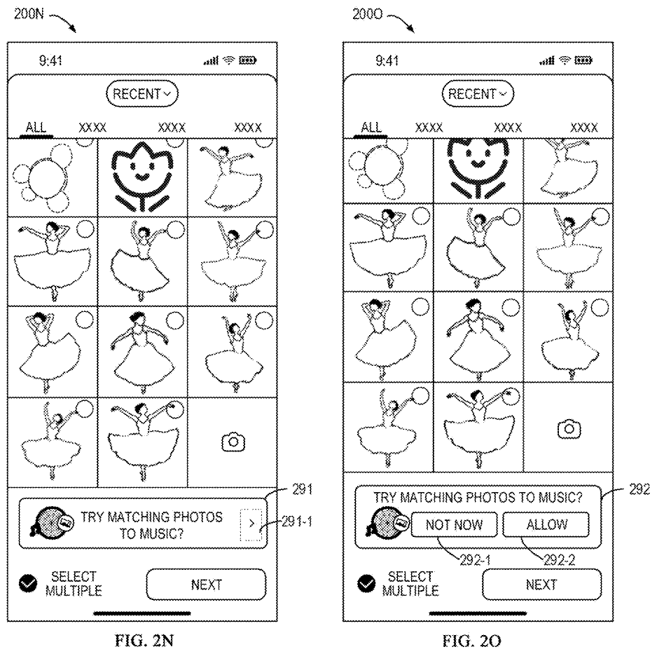

Some example interaction processes according to embodiments of the present disclosure will be described below with reference to FIGS. 2A-2O. FIGS. 2A-2O illustrate example interfaces 200A-200O, which may be provided, for example, by the electronic device 110 shown in FIG. 1, according to some embodiments of the present disclosure.

In some embodiments, the electronic device 110 may present an interface 200A as shown in FIG. 2A, and the interface 200A may be a viewing interface (also referred to as a music detail page) of music content (e.g., music A). As an example, such music A may be selected by the user 140 or screened by the application 120 based on a predetermined screening manner. The music A may be in a variety of audio forms, for example, the music A may include, but is not limited to, music, music segments, music content extracted from media content, or the like. The present disclosure is not intended to limit specific attributes such as a source, audio form, or the like of such music A.

As an example, such a viewing interface may be presented by a user's trigger, or otherwise triggered to be presented. For example, the user 140 may trigger presentation of the interface 200A by triggering a viewing control associated with the music A during viewing of the media content. As another example, the user 140 may also search for the music A in a search interface, thereby triggering presentation of the interface 200A.

Taking an example of the user 140 triggering presentation of the interface 200A during viewing of the media content, referring to FIG. 2B, an interface 200B shown in FIG. 2B may be a playback interface of media content. According to the interface 200B shown in FIG. 2B, the user 140 may view the media content 221 played by the playback interface, the media content 221 may be media content associated with the music A. It should be understood that such media content may include images, videos, or the like, and various media content, various media materials, and the like described below may also include images, videos, and the like, and details are not described herein again.

Further, the interface 200B may provide a control 222 to indicate the music A, whereby the user 140 may trigger to present a viewing interface of the music A shown in the interface 200A by triggering the control 222 in the interface 200B. It should be understood that such a specific implementation of triggering to present the interface 200A via the interface 200B is merely illustrative, and the present disclosure is not intended to limit the particular manner in which the viewing interface for presenting music content is triggered.

Returning to FIG. 2A, the electronic device 110 may present description content 211 of the music A in the interface 200A, e.g., the description content 211 may include a name of the music A, an associated user of the music A (e.g., a singer of the music A, a poster of the music A, etc.), a description text of the music A, a cover page of the music A, and the like. As an example, the user 210 may also trigger playing of the music A through a trigger control 212. Thus, the user 140 may more conveniently obtain relevant information of the music A based on the interface 200A.

In some embodiments, the electronic device 110 may present at least one reference media content associated with the music A in interface 200A, e.g., such reference media content may include reference media content 213-1, reference media content 213-2, reference media content 213-3, and/or the like, which may also be collectively or individually referred to as reference media content 213. Thus, the user 140 may view more media content associated with the music A by triggering the reference media content 213. As an example, the reference media content 213 may be created and/or uploaded by other users, and may also include content created and/or uploaded by the user 140. Based on this, the user 140 may refer to the reference media content 213 for content creation, thereby improving the efficiency of posting the media content by the user 140.

In some embodiments, the user 140 may trigger capturing media content associated with the music A by a triggering entry 214. For example, the user 140 triggers the entry 214, the electronic device 110 may present a capture interface of the media content to the user 140, and apply the music A to framing content in the capture interface.

To improve the efficiency of content posting, in some embodiments, the electronic device 110 may provide a first entry 215 at the viewing interface of music content. As an example, the first entry 215 may be a functional entry that guides users to be recommended media materials associated with the music A. As an example, the first entry 215 may be presented at any suitable location on the interface 200A, which is not limited in the present disclosure.

As an example, such media materials may include image media materials, video media materials, or the like. As an example, such a group of media materials may be determined from a media material set. Such a media material set may be a media material set corresponding to a predetermined content source. The content source may represent an entity or position that produces, provides, or stores a media material set. For example, such a predetermined content source may indicate installing media materials of the application 120 stored locally in the electronic device 110. For another example, such a predetermined content source may also be a media content library associated with the user 140, for example, a work draft box of the user 140 in the application 120, or the like. In the following embodiments of the present disclosure, an example in which such a predetermined content source may indicate installing media materials of the application 120 stored locally in the electronic device 110 is used as an example for description. It should be understood that the obtaining and use of such a group of media materials is performed with the user's awareness and consent, and both follow the corresponding laws and regulations and related provisions.

In some embodiments, if the user 140 triggers the first entry 215, presentation of the first editing interface may be triggered, and the first media material in the recalled group of media materials may be presented in the first editing interface. In this case, the user 140 cannot perceive such a matching process. If the user 140 triggers the first entry 215, the electronic device 110 may present an interface 200C shown in FIG. 2C for the user 140. The interface 200C may include a card 231 displaying a player of the music A, and the card 231 may indicate playing the music A. Further, the card 231 may play a media material recall animation for an album to indicate a process of recalling the media material that matches with the music A from such an album. As an example, such a media material recall animation may present at least a portion of the media material that is recalled and the recalled at least a portion of the media material is presented in different sizes in such a media material recall animation. For example, according to an interface 200D shown in FIG. 2D, the electronic device 110 may play an animation for the media material 241 in the card 231 to support recall of the media material 241. As an example, according to an interface 200E shown in FIG. 2E, the electronic device 110 may enlarge the media material 241 to indicate that the media material 241 is recalled. Thus, the electronic device 110 can improve the efficiency of obtaining information by the user 140 from the interface presented by the application 120.

In some embodiments, in order to improve the degree of matching between the recalled group of media materials and the music A, such a group of media materials may be determined from an album based on a relevance between the music A and the album. As an example, such correlation may be determined by matching content information included in the music A and content information of the album. For example, the content information included in the music A includes, but is not limited to, content information such as melody, lyrics and the like of the music A. The content information of the album includes, but is not limited to, visual elements contained in images, theme(s) of the images, a theme of at least one frame of a video, a theme of the video, and the like. Therefore, the matching degree between the group of media elements and the music A can be improved, and the quality of the subsequently posted media content corresponding to the at least one media material of the group of media materials can be improved. In addition, the user 140 does not need to manually find the media material matching with the music A from the album. Therefore, the embodiments of the present disclosure can further improve the efficiency of content posting.

In some embodiments, after the playback of the media material recall animation has finished, the electronic device 110 may present the first editing interface. For example, the electronic device 110 may present an interface 200F shown in FIG. 2F. The interface 200F may be a first editing interface, and the user 140 may at least preview and post the media content through such a first editing interface.

As an example, according to the interface 200F shown in FIG. 2F, the electronic device 110 may present a first media material (for example, a media material 241) of a group of media materials, and may provide a posting entry 242 to support the user 140 to quickly post the media content. As an example, if the user 140 triggers the posting entry 242, the electronic device 110 may post the first media content corresponding to the media material 241. Thus, the user 140 may post the first media content matching with the music content without editing the media content, so that the efficiency of content posting can be improved.

In some embodiments, to improve the quality of the media content, the electronic device 110 may provide an editing entry 243 (also referred to as a first editing entry) to support the user 140 editing the media material 241. For example, the user 140 may trigger the editing entry 243 to trigger presenting of a second editing interface. Further, the electronic device 110 may edit the media material 241 via the second editing interface and present the edited media material 241 in the first editing interface.

In some embodiments, such an editing entry 243 may support a user to conveniently edit (e.g., automatically clip, etc.) the media material 241. For example, if the user 140 triggers the editing entry 243, the electronic device 110 may present an interface 200G shown in FIG. 2G, and the interface 200G may be a form of the second editing interface. Further, the electronic device 110 may present a plurality of media resources in the interface 200G for the user 140 to select and edit the media material 241 based on a selected first media resource. As an example, such media resources may include media template resources, image effects resources, and the like. Thus, the user 140 may edit the media material 241 more quickly through such media resources.

As an example, according to the interface 200G shown in FIG. 2G, the user 140 may select a media resource 251 (also referred to as a first media resource) from a media resource 251 (for example, referred to as a resource 1), a media resource 252 (for example, referred to as a resource 2), a media resource 253 (for example, referred to as a resource 3), and a media resource 254 (for example, referred to as a resource 4) presented by the interface 200G, to trigger editing of the media material 241 based on the media resource 251.

To improve user interaction efficiency, in some embodiments, the electronic device 110 may receive a first switching operation in the interface 200G to switch the first media resource to a second media resource. As an example, the first switching operation may be any suitable operation, for example, may be a sliding operation, a clicking operation, or the like. As such, the electronic device 110 may edit the media material 241 based on the second media resource. For example, the user 140 may perform sliding operation laterally (or longitudinally, vertically, etc.) in the interface 200G to replace the media resource 251 with other media resources. Based on this, the embodiments of the present disclosure can improve the quality of the media resource for editing the media material 241, thereby improving the quality of subsequently posted media content.

In some embodiments, the plurality of media resources presented by the interface 200G may be determined from a media resource set by the electronic device 110 based on the music A and/or the media material 241. For example, the plurality of media resources may include media resources of the media resource set that are more matched with the music A and/or the media material 241. Thus, the embodiments of the present disclosure may not need the user 140 to manually select the media resource to be applied, thereby further improving the interaction efficiency between the user 140 and the application 120, and further improving the efficiency of content posting.

Returning to FIG. 2F, the electronic device 110 may present a predetermined element 244 on the first editing interface, and the predetermined element 244 may indicate description information associated with the media material 241. For example, such description information may indicate location information, time information, etc. associated with the media material 241. In some embodiments, the obtaining and use of such description information is performed with the user's awareness and consent, and both follow the corresponding laws and regulations and related provisions.

Further, the predetermined element 244 may correspond to a first style. In order to improve the quality of the predetermined element 244, the electronic device 110 may support the user 140 to replace the style of the predetermined element 244. Specifically, in response to receiving an adjustment operation on the predetermined element 244, the electronic device 110 may update the predetermined element 244 from the first style to a second style. As an example, the adjustment operation may be any appropriate operation, for example, an operation of clicking on the predetermined element 244, or an operation of clicking on any other appropriate position in the interface 200F, or the like.

In some embodiments, the posted first media content may be associated with the music A. For example, the first media content may include music A as a soundtrack, or the first media content may include an anchor point that is guided to the music A. Thus, the embodiments of the present disclosure can support the user to post the first media content associated with the music A through the viewing interface of the music A, and improve the quality of the first media content. In addition, the posted first media content may also be viewed by other users subsequently through the music content, thereby further improving the transmission efficiency of the first media content subsequently.

In some embodiments, the electronic device 110 may also support the user 140 replacing the applied music in the interface 200F, for example, the user 140 may delete the applied music A through a trigger control 247, or replace the music A as music B. As an example, such music B may be obtained by searching by the user 140 or may be selected by the user 140 from a plurality of music options provided by the application 120. Thus, the embodiment of the present disclosure may further improve the quality of audios in the media content posted by the user 140 subsequently.

In some embodiments, the electronic device 110 may support the user editing the recalled media material 241 more deeply. For example, according to an interface 200H shown in FIG. 2H, such an interface 200H may be a form of a first editing interface. Further, the electronic device 110 provides an editing entry 248 (also referred to as a second editing entry) in the interface 200H. The user 140 may trigger presentation of a deeper third editing interface for the media material 241 by triggering the editing entry 248. For example, such a third editing interface may include an interface 200I shown in FIG. 2I.

Further, according to the interface 200I shown in FIG. 2I, the user 140 may edit the media material 241 more deeply. Specifically, the electronic device 110 may receive at least one editing operation in the interface 200I to edit the media material 241. As an example, such at least one editing operation includes, but is not limited to, adding texts, adjusting areas, configuring stickers, applying effects, applying filters, configuring subtitles, and the like. For example, the user 140 may trigger a control 255 to trigger addition of specified texts to the media element 241. As another example, the user 140 may trigger a control 256 to trigger addition of specified stickers to the media element 241, etc.

Further, the user 140 may trigger preview of the edited media element 241 by triggering a control 257 to further adjust and/or post the media content corresponding to the edited media element 241. Further, in response to receiving a posting request at the third editing interface, the electronic device 110 may post the second media content associated with the edited media element 241. Based on this, the embodiments of the present disclosure may support the user 140 editing a single media content deeply, thereby further improving the quality of the media content created by the user 140.

Returning to FIG. 2F, the electronic device 110 may further support the user 140 selecting other media materials or a plurality of media materials in the group of media materials. For example, according to the interface 200F shown in FIG. 2F, the user 140 may switch the media material through, for example, sliding the card 231 laterally (or in other directions). For example, the user 140 switches the media material 241 to the second media material. Thus, the user 140 may post the third media content corresponding to the second media material through triggering the posting entry 242 in the interface 200F.

In some embodiments, the first editing interface may further provide a viewing control to support the user 140 selecting a plurality of media materials. For example, according to the interface 200F shown in FIG. 2F, the user 140 may trigger to select a plurality of media materials from the recalled group of media materials by triggering a viewing control 246. As an example, the user 140 triggers the viewing control 246 to trigger the electronic device 110 to present the recalled group of media materials.

As an example, the user 140 triggers the viewing control 246 and may trigger presentation of an interface 200J shown in FIG. 2J, and the interface 200J may include a viewing interface of the recalled group of media materials. As an example, the electronic device 110 may recall the media material 241, a media material 261, a media material 262, a media material 263, a media material 264, and/or the like. Thus, the user may select a plurality of media materials from the group of media materials presented by the interface 200J.

Further, the electronic device 110 may present a fourth editing interface corresponding to the selected plurality of media materials to edit such a plurality of media materials. As an example, the user 140 may apply the media resource for the plurality of media materials through triggering an entry 266 in the interface 200J, or performing at least one editing operation for the plurality of media materials through triggering an entry 265. As an example, the plurality of media materials may be edited separately or edited as a whole. For example, the fourth editing interface may include an interface 200K shown in FIG. 2K, and the user 140 may separately edit the media material 241 in the interface 200K, or may edit a video material formed by the selected media material 241 and the media material 261. For example, the user 140 may add texts through a control 271, add stickers through a control 272, or the like. Further, the user 140 may trigger an entry 273 to trigger previewing and/or posting the fourth media content. Specifically, the details of the specific editing implementation for the plurality of media materials are not described herein again in the embodiments of the present disclosure, and the specific editing details may be implemented with reference to the above editing for the media material 241.

In some embodiments, to protect the security of the privacy data of the user, the electronic device 110 may, in response to receiving authorization confirmation from the user 140 for the predetermined content source, obtain the media material set, and match and obtain a group of media materials associated with the music content from the media material set corresponding to the predetermined content source, to be presented in the first editing interface. In order to improve the efficiency of the user 140 creating the media material, automatically matching the media material is guided for the user 140. The electronic device 110 may present an authorization control associated with the predetermined content source to support the user selecting to match the media material set corresponding to the predetermined content source with the music content.

Further, the user may confirm, by clicking the authorization control, authorization to match the media material set corresponding to the predetermined content source with the music content, and at this time, the electronic device 110 may match the media material set corresponding to the predetermined content source with the music content in response to a trigger for the authorization control, to obtain a group of media materials.

In some embodiments, the electronic device 110 may present an authorization component. Such an authorization component may include an authorization control and a non-authorization control. The user 140 may authorize matching the media material set corresponding to the predetermined content source with the music content by triggering the authorization control in the authorization component.

As an example, such an authorization component may be presented by user 140 triggering the first entry 215. For example, according to an interface 200L shown in FIG. 2L, the electronic device 110 may present an authorization component 281 and support the user 140 selecting an authorization control 281-1 or a non-authorization control 281-2.

As an example, such authorization control may also be presented at a playback interface of the music content. For example, according to an interface 200M shown in FIG. 2M, the electronic device 110 may provide an authorization control 282. Further, the electronic device 110 may present guidance information for reminding authorization. For example, such guidance information may include “match photos from your album for music?”, “try matching photos for music?”, or the like. As an example, according to the interface 200M shown in FIG. 2M, the electronic device 110 may present guidance information 283 to guide the user 140 to authorize matching the media material set corresponding to the predetermined content source with the music content. If the user 140 triggers the authorization control 282, the electronic device 110 may match the media material set corresponding to the predetermined content source with the music content to present the matched group of media materials on the first editing interface.

In some embodiments, if the user 140 does not authorize matching the media material set corresponding to the predetermined content source with the music content, the electronic device 110 may present a plurality of candidate media materials to the user for selection by the user 140.

In order to improve the efficiency of the user 140 creating the media material, the electronic device 110 may present the authorization control on a viewing interface (for example, an album or the like) of the candidate media material, to assist the user in screening the media material matching with the music content. As an example, according to an interface 200N shown in FIG. 2N, the electronic device 110 may present an authorization component 291, and authorize, by triggering an authorization control 292, matching the media material set corresponding to the predetermined content source with the music content.

As an example, a plurality of manners for guiding the user 140 to authorize through the media material selection interface may be included. For example, according to an interface 200N shown in FIG. 2N, the electronic device 110 may present the guidance component 291 to guide the user to perform an authorization operation. For another example, according to an interface 200O shown in FIG. 2O, the electronic device 110 may present the authorization component 292, and the authorization component 292 may include an authorization control 292-1 and a non-authorization control 292-2 to support the user 140 to configure whether to authorize matching the media material set corresponding to the predetermined content source with the music content.

It should be understood that the specific content items (for example, a music name, a text content presented by the element, a resource name, a function text indicated by the control, specific contents of the material, and the like) mentioned in the embodiments of the present disclosure are merely illustrative, and the present disclosure is not intended to be limited thereto.

In this way, according to the embodiments of the present disclosure, the first entry may be presented on the viewing interface of the music content to support more rapid creation of the media content, and the media content may be quickly created by the user based on the music content without switching to other interfaces or performing additional steps, so that the cost of content posting can be reduced, and the efficiency of content posting can be improved. In addition, according to the embodiment of the present disclosure, the first media material may be at least recommended to the user based on the relevance between the music content and the media content set, and the user does not need to manually select the materials, further improving the efficiency of content posting, and improving the quality of the posted media content.

Therefore, the embodiment of the present disclosure can improve the efficiency of content posting and improve the quality of posted media content.

### Example Process

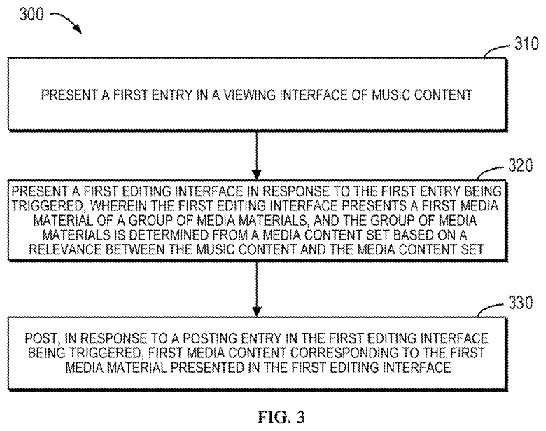

FIG. 3 illustrates a flowchart of an example process 300 of content posting according to some embodiments of the present disclosure. The process 300 may be implemented at the electronic device 110. The process 300 is described below with reference to FIG. 1.

As shown in FIG. 3, at block 310, the electronic device 110 presents a first entry in a viewing interface of the music content.

At block 320, the electronic device 110 presents a first editing interface in response to the first entry being triggered. The first editing interface presents a first media material of a group of media materials determined from a media content set based on a relevance between the music content to the media content set.

At block 330, the electronic device 110 posts, in response to a posting entry in the first editing interface being triggered, first media content corresponding to the first media material presented in the first editing interface.

In some embodiments, a first editing entry is presented in the first editing interface, and before posting the first media content corresponding to the first media material presented in the first editing interface, the process 300 further includes: presenting a second editing interface in response to the first editing entry being triggered; editing the first media material via the second editing interface; and presenting the edited first media material in the first editing interface.

In this way, the embodiments of the present disclosure may support the user editing the first media material, improving the quality of the first media material, and improving the quality of the first media content.

In some embodiments, editing the first media material via the second editing interface includes: presenting a plurality of media resources in the second editing interface; and editing, in response to a first media resource of the plurality of media resources being selected, the first media material based on the first media resource.

In this way, the embodiments of the present disclosure may support more convenient editing of the first media material by using a plurality of media resources without complicated and cumbersome editing processes, thereby improving the efficiency of editing the first media material.

In some embodiments, the plurality of media resources includes: a media template resource; and/or an image effect resource.

In this way, the embodiments of the present disclosure may provide multiple types of media resources, thereby improving richness of media resources and further improving quality of edited first media materials.

In some embodiments, the process 300 further includes: switching, in response to receiving a first switching operation in the second editing interface, the first media resource to a second media resource to edit the first media material based on the second media resource.

In this way, the embodiments of the present disclosure may support the user to more conveniently switch the media resource, and may support the user to quickly preview the editing effect corresponding to the media resource, thereby further improving the efficiency of editing the first media material.

In some embodiments, a second editing entry is presented in the first editing interface, and the process 300 further includes: presenting a third editing interface in response to the second editing entry being triggered; receiving, via the third editing interface, at least one editing operation for the first media material; and posting, in response to receiving a posting request in the third editing interface, second media content associated with the edited first media material.

In this way, the embodiments of the present disclosure may support the user to more deeply edit the media content through the second editing entry, and support a plurality of editing operations through the third editing interface, thereby further improving the quality of the first media material, thereby further improving the quality of the first media content.

In some embodiments, the process 300 further includes: presenting an authorization control associated with a predetermined content source; and obtaining, in response to a trigger for the authorization control, the media content set corresponding to the predetermined content source.

In this way, the embodiments of the present disclosure may facilitate the user to manage authorization of the content source by presenting the authorization control associated with the predetermined content source, thereby effectively improving the efficiency of authorization management.

In some embodiments, after presenting the first editing interface, the process 300 further includes: switching, in response to receiving a second switching operation in the first editing interface, the first editing interface to a second media material of the group of media materials; and posting, in response to the posting entry in the first editing interface being triggered, third media content corresponding to the second media material presented in the first editing interface.

In this way, the embodiments of the present disclosure may support the user to switch and view different items of the group of media materials by performing the second switching operation in the first editing interface, and this dynamic switching function may effectively improve viewing efficiency of media materials and thereby further improve the efficiency of media content creation.

In some embodiments, the process 300 further includes: presenting, in response to a selection of a viewing control in the first editing interface, a viewing interface of the group of media materials; presenting, in response to a selection of a plurality of media materials from the group of media materials, a fourth editing interface corresponding to the selected plurality of media materials; and posting, via the fourth editing interface, fourth media content corresponding to the selected plurality of media materials.

In this way, the embodiments of the present disclosure may enable the user to select a plurality o f media materials from a group of media materials for editing and posting related media content, thereby effectively improving the efficiency of editing and posting. In addition, after the editing is completed, the fourth media content corresponding to the selected plurality of media materials may be directly posted, simplifying the posting process, and improving the efficiency of content posting.

In some embodiments, the posted first media content is associated with the music content.

In this way, the embodiments of the present disclosure may support the user to create the first media content associated with the music content, thereby improving the quality of the first media content. In addition, the posted first media content may also be viewed by other users through the music content subsequently, thereby further improving the transmission efficiency of the first media content subsequently.

In some embodiments, the process 300 further includes: presenting a predetermined element in the first editing interface. The predetermined element is to be included in the posted first media content, and the predetermined element indicates description information associated with the first media material.

In this way, the embodiments of the present disclosure can improve the richness of the first media content, thereby further improving the quality of the first media content.

In some embodiments, the process 300 further includes: updating, in response to receiving an adjustment operation for the predetermined element, the predetermined element from a first style to a second style.

In this way, the embodiments of the present disclosure may support the quick switching of styles of the predetermined element, thereby improving the quality of the predetermined element, and improving the quality of the first media content including the predetermined element.

### Example Apparatus and Device

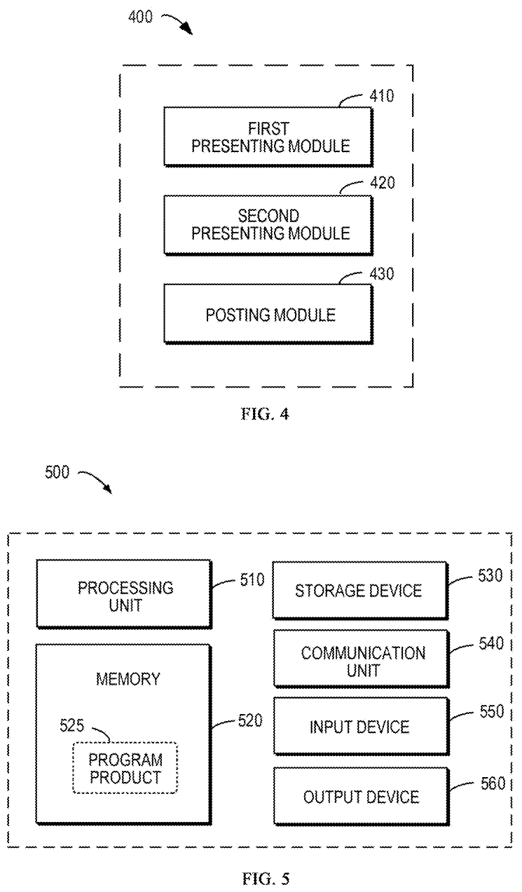

Embodiments of the present disclosure also provide a corresponding apparatus for implementing the above method or process. FIG. 4 illustrates a schematic structural block diagram of an example apparatus 400 for content posting according to some embodiments of the present disclosure. The apparatus 400 may be implemented or included in the electronic device 110. Various modules/components in the apparatus 400 may be implemented by hardware, software, firmware, or any combination thereof.

As shown in FIG. 4, the apparatus 400 includes a first presenting module 410 configured to present a first entry in a viewing interface of music content; a second presenting module 420 configured to present a first editing interface in response to the first entry being triggered, the first editing interface presenting a first media material of a group of media materials, and the group of media materials being determined from a media content set based on a relevance between the music content and the media content set; and a posting module 430 configured to post, in response to a posting entry in the first editing interface being triggered, first media content corresponding to the first media material presented in the first editing interface.

In some embodiments, a first editing entry is presented in the first editing interface, and the apparatus 400 further includes a third presenting module configured to: present a second editing interface in response to the first editing entry being triggered; edit the first media material via the second editing interface; and present the edited first media material in the first editing interface.

In some embodiments, the third presenting module is further configured to: present a plurality of media resources in the second editing interface; and edit, in response to a first media resource of the plurality of media resources being selected, the first media material based on the first media resource.

In some embodiments, the plurality of media resources includes: a media template resource; and/or an image effect resource.

In some embodiments, the apparatus 400 further includes a first switching module configured to switch, in response to receiving a first switching operation in the second editing interface, the first media resource to a second media resource to edit the first media material based on the second media resource.

In some embodiments, a second editing entry is presented in the first editing interface, and the apparatus 400 further includes a fourth presenting module configured to: present a third editing interface in response to the second editing entry being triggered; receive, via the third editing interface, at least one editing operation for the first media material; and post, in response to receiving a posting request in the third editing interface, second media content associated with the edited first media material.

In some embodiments, the apparatus 400 further includes an obtaining module configured to: present an authorization control associated with a predetermined content source; and obtain, in response to a trigger for the authorization control, the media content set corresponding to the predetermined content source.

In some embodiments, the apparatus 400 further includes a second switching module configured to: switch, in response to receiving a second switching operation in the first editing interface, the first editing interface to a second media material of the group of media materials; and post, in response to the posting entry in the first editing interface being triggered, third media content corresponding to the second media material presented in the first editing interface.

In some embodiments, the apparatus 400 further includes a fifth presenting module: presenting, in response to a selection of a viewing control in the first editing interface, a viewing interface of the group of media materials; presenting, in response to a selection of a plurality of media materials from the group of media materials, a fourth editing interface corresponding to the selected plurality of media materials; and posting, via the fourth editing interface, fourth media content corresponding to the selected plurality of media materials.

In some embodiments, the posted first media content is associated with the music content.

In some embodiments, the apparatus 400 further includes a sixth presenting module configured to: present a predetermined element in the first editing interface. The predetermined element is to be included in the posted first media content, and the predetermined element indicates description information associated with the first media material.

In some embodiments, the apparatus 400 further includes an updating module configured to update, in response to receiving an adjustment operation for the predetermined element, the predetermined element from a first style to a second style.

The modules included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOC), complex programmable logic devices (CPLDs), and the like.

FIG. 5 illustrates a block diagram of an electronic device 500 in which one or more embodiments of the present disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be configured to implement the electronic device 110 of FIG. 1 or the apparatus 400 of FIG. 4.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In a multiprocessor system, a plurality of processing units executes computer-executable instructions in parallel to improve the parallel processing capability of the electronic device 500.

The electronic device 500 generally includes a plurality of computer storage media. Such media may be any available media that is accessible by the electronic device 500, including, but not limited to, volatile and non-volatile media, removable and non-removable media. The memory 520 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 530 may be a removable or non-removable medium and may include a machine-readable medium, such as a flash drive, a magnetic disk, or any other medium, which may be capable of storing information and/or data and may be accessed within the electronic device 500.

The electronic device 500 may further include additional removable/non-removable, volatile/non-volatile storage media. Although not shown in FIG. 5, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating through a communication connection. Thus, the electronic device 500 may operate in a networked environment using logical connections with one or more other servers, a network personal computer (PC), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, the external device such as a storage device, a display device, etc., communicates with one or more devices that enable the user to interact with the electronic device 500, or communicates with any device (e.g., a network card, a modem, etc.) that enables the electronic device 500 to communicate with one or more other electronic devices. Such communication may be performed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, and the computer-executable instructions being executed by the processor to implement the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combinations of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in one or more blocks in the flowchart(s) and/or block diagram(s). These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on the computer, other programmable data processing apparatus, or other apparatus implement the functions/acts specified in one or more blocks in the flowchart(s) and/or block diagram(s).

The flowchart and block diagrams in the figures show the architecture, functionality, and operation that may be possibly implemented by a system, a method, and a computer program product according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagram(s) and/or flowchart(s), as well as combinations of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for content posting, comprising:
presenting a first entry in a viewing interface of music content;
presenting a first editing interface in response to the first entry being triggered, wherein the first editing interface presents a first media material of a group of media materials, and the group of media materials is determined from a media content set based on a relevance between the music content and the media content set; and
posting, in response to a posting entry in the first editing interface being triggered, first media content corresponding to the first media material presented in the first editing interface.

2. The method of claim 1, wherein a first editing entry is presented in the first editing interface, and before posting the first media content corresponding to the first media material presented in the first editing interface, the method further comprises:
presenting a second editing interface in response to the first editing entry being triggered;
editing the first media material via the second editing interface; and
presenting the edited first media material in the first editing interface.

3. The method of claim 2, wherein editing the first media material via the second editing interface comprises:
presenting a plurality of media resources in the second editing interface; and
editing, in response to a first media resource of the plurality of media resources being selected, the first media material based on the first media resource.

4. The method of claim 3, wherein the plurality of media resources comprises: a media template resource;
and/or an image effect resource.

5. The method of claim 3, further comprising:
switching, in response to receiving a first switching operation in the second editing interface, the first media resource to a second media resource to edit the first media material based on the second media resource.

6. The method of claim 1, wherein a second editing entry is presented in the first editing interface, and the method further comprises:
presenting a third editing interface in response to the second editing entry being triggered;
receiving, via the third editing interface, at least one editing operation for the first media material; and
posting, in response to receiving a posting request in the third editing interface, second media content associated with the edited first media material.

7. The method of claim 1, further comprising:
presenting an authorization control associated with a predetermined content source; and
obtaining, in response to a trigger for the authorization control, the media content set corresponding to the predetermined content source.

8. The method of claim 1, wherein after presenting the first editing interface, the method further comprises:
switching, in response to receiving a second switching operation in the first editing interface, the first editing interface to a second media material of the group of media materials; and
posting, in response to the posting entry in the first editing interface being triggered, third media content corresponding to the second media material presented in the first editing interface.

9. The method of claim 1, further comprising:
presenting, in response to a selection of a viewing control in the first editing interface, a viewing interface of the group of media materials;
presenting, in response to a selection of a plurality of media materials from the group of media materials, a fourth editing interface corresponding to the selected plurality of media materials; and
posting, via the fourth editing interface, fourth media content corresponding to the selected plurality of media materials.

10. The method of claim 1, wherein the posted first media content is associated with the music content.

11. The method of claim 1, further comprising:
presenting a predetermined element in the first editing interface, wherein the predetermined element is to be included in the posted first media content, and the predetermined element indicates description information associated with the first media material.

12. The method of claim 11, further comprising:
updating, in response to receiving an adjustment operation for the predetermined element, the predetermined element from a first style to a second style.

13. An electronic device, comprising:
at least one processor; and
at least one memory coupled to the at least one processor and storing instructions for execution by the at least one processor, the instructions, when executed by the at least one processor, causing the electronic device to perform acts comprising:
presenting a first entry in a viewing interface of music content;
presenting a first editing interface in response to the first entry being triggered, wherein the first editing interface presents a first media material of a group of media materials, and the group of media materials is determined from a media content set based on a relevance between the music content and the media content set; and
posting, in response to a posting entry in the first editing interface being triggered, first media content corresponding to the first media material presented in the first editing interface.

14. The electronic device of claim 13, wherein a first editing entry is presented in the first editing interface, and before posting the first media content corresponding to the first media material presented in the first editing interface, the acts further comprise:
presenting a second editing interface in response to the first editing entry being triggered;
editing the first media material via the second editing interface; and
presenting the edited first media material in the first editing interface.

15. The electronic device of claim 13, wherein a second editing entry is presented in the first editing interface, and the acts further comprise:
presenting a third editing interface in response to the second editing entry being triggered;
receiving, via the third editing interface, at least one editing operation for the first media material; and
posting, in response to receiving a posting request in the third editing interface, second media content associated with the edited first media material.

16. The electronic device of claim 13, wherein the acts further comprise:
presenting an authorization control associated with a predetermined content source; and
obtaining, in response to a trigger for the authorization control, the media content set corresponding to the predetermined content source.

17. The electronic device of claim 13, wherein after presenting the first editing interface, the acts further comprise:
switching, in response to receiving a second switching operation in the first editing interface, the first editing interface to a second media material of the group of media materials; and
posting, in response to the posting entry in the first editing interface being triggered, third media content corresponding to the second media material presented in the first editing interface.

18. The electronic device of claim 13, wherein the acts further comprise:
presenting, in response to a selection of a viewing control in the first editing interface, a viewing interface of the group of media materials;
presenting, in response to a selection of a plurality of media materials from the group of media materials, a fourth editing interface corresponding to the selected plurality of media materials; and
posting, via the fourth editing interface, fourth media content corresponding to the selected plurality of media materials.

19. The electronic device of claim 13, wherein the acts further comprise:
presenting a predetermined element in the first editing interface, wherein the predetermined element is to be included in the posted first media content, and the predetermined element indicates description information associated with the first media material.

20. A non-transitory computer-readable storage medium having a computer program stored thereon, wherein the computer program, when executed by a processor, perfoms acts comprising:
presenting a first entry in a viewing interface of music content;
presenting a first editing interface in response to the first entry being triggered, wherein the first editing interface presents a first media material of a group of media materials, and the group of media materials is determined from a media content set based on a relevance between the music content and the media content set; and
posting, in response to a posting entry in the first editing interface being triggered, first media content corresponding to the first media material presented in the first editing interface.
